(19) United States
(12) Patent Application Publication
(10) Pub. No.: US 2016/0050169 A1
(43) Pub. Date: Feb. 18, 2016

(54) Method and System for Providing Personal Emoticons

(71) Applicants: Shlomi Ben Atar, Givatayim (IL); May Hershkovitz Reshef, Tel Aviv (IL)

(72) Inventors: Shlomi Ben Atar, Givatayim (IL); May Hershkovitz Reshef, Tel Aviv (IL); Eli Basson, Kfar Sava (IL)

(21) Appl. No.: 14/926,840

(22) Filed: Oct. 29, 2015

Related U.S. Application Data
(63) Continuation-in-part of application No. PCT/IL2014/050379, filed on Apr. 24, 2014.

(30) Foreign Application Priority Data
Apr. 29, 2013 (IL) 226047

(51) Int. Cl. H04L 12/58; G06T 5/20; G06T 11/00; G06K 9/00

(52) U.S. Cl. CPC H04L 51/046; G06K 9/00302; G06T 5/20; G06T 11/00

(57) ABSTRACT

The present invention relates to a method of providing personal emoticons by applying one or more image processing filters and/or algorithms on a self-portrait image for performing at least one of the following tasks: enhancing said provided image, recognizing the face expression, and/or emphasizing the face expression represented by the provided image, and converting said process image into one or more emoticon/s format such that the image file is standardize into a pixel array of uniform dimensions to be used as personal emoticons in one or more applications and/or operating system based platforms by a software component that allows a user to enter characters on a computer based device.

### FIELD OF THE INVENTION

The present invention relates to the field of instant messaging. More particularly, the invention relates to a method for providing personal emotion expression icons (emoticon) either manually or by automatically identifying the person's mood and/or its status.

### BACKGROUND OF THE INVENTION

As more users are connected to the Internet and conduct their social activities electronically, emoticons have acquired immense popularity and hence importance in instant messaging, chats, social networks, applications, etc. The variety of available emoticons has increased tremendously, from a few types of “happy faces” to a multitude of elaborate and colorful animations. However, there are now so many emoticons available that some applications may be reaching a limit on the number of pre-established (“pre-packaged”) emoticons that can be included with or managed by an application. There is an exhaustion point for trying to provide a pre-packaged emoticon for every human emotion. Still, users clamor for more emoticons, and especially for more nuanced emoticons that will better express the uniqueness of their own emotions and situations.

It is an object of the present invention to provide a system which is capable of providing emoticons that express the uniqueness of each user.

It is another object of the present invention to provide a system which is capable of automatically identifying the current mood of a user.

It is yet another object of the present invention to provide a system which is capable of automatically changing the mood status of a user in variety of applications and/or operation system platforms.

It is a further object of the present invention to provide a system which is capable of automatically generating a feedback to the user according to the user's current mood status.

Other objects and advantages of the invention will become apparent as the description proceeds.

### SUMMARY OF THE INVENTION

The present invention relates to a method for providing personal emoticons, which comprises:
a. providing at least one self-portrait image (e.g., a digital photo) that represent a static face expression of an individual user, either by capturing a new self-portrait image/s of said individual or by selecting an existing image file/s that contains at least one face;
b. processing said provided at least one self-portrait image by applying one or more image processing filters and/or algorithms for performing at least one of the following tasks: enhancing said provided image, recognizing the face expression, and/or for emphasizing the face expression represented by the provided image, wherein the processing can be done either locally at a computer based device and/or remotely at a remote emoticons server; and
c. converting each processed image into an emoticon standardized form to be used as personal emoticons in one or more applications and/or operating system based platforms, wherein, for example, the converted image(s) can be implemented in any displayable form of a software component that allows a user to enter characters on a computer based device (e.g., smartphone or PC), such as a ruler form, a menu form or as an on-screen virtual keyboard form (e.g., as an extension/add-on to an existing virtual keyboard layout such as the on-screen keyboard of an iPhone's operation system (iOS)).

According to an embodiment of the invention, the processing of the image involves the applying of one or algorithms, in particular based on one or more of the following methods:
i. neural Networks (learning N faces with desired emoticon and applying the algorithm to the N+1 face);
ii. Vector drawing the outlines of the recognized face, thereby transforming the image to a painting and/or caricature that express the provided face;
iii. learning the personal mood through analysis of known tonus of the face's organs, based on Ekman method;
iv. breaking the face into predefined units (i.e., eyes, lips, nose, ears and more), processing each unit by itself by a predefined specific calculation and then assemble all units together to create the face with the desired emoticon.

According to an embodiment of the invention, the method further comprises enabling to add the personal emoticons to a software component that allows a user to enter characters while using a his computerized device (such as mobile, PC, Tablet and alike), in particular in form of a virtual keyboard or a ruler/menu.

According to an embodiment of the invention, the method further comprises storing the personal emoticons locally (e.g., in a mobile device) and/or in a remote emoticons server for adding said personal emoticons into an on-line account associated with the individual user, thereby enabling to use said personal emoticons in a variety of applications and/or platforms.

According to an embodiment of the invention, the capturing of a new self-portrait image involves optionally the displaying of a guiding mask layer on top of a live image that is displayed on a screen of an image capturing device (such as a PC, smart-phone or tablet), for allowing positioning the user's face in an appropriate image capturing position.

According to an embodiment of the invention, the method further comprises generating additional self-portrait emotions images deriving from the provided self-portrait image by performing the steps of:
a. allowing a user to mark predefined reference points on top of said provided self-portrait image, wherein each reference point represent a facial parameter with respect to the gender of the user; and/or
b. applying image processing algorithm(s) to said provided self-portrait image according to said marked predefined reference points and the relation between their location with respect to a reference human face, such that each generated self-portrait image will express a different expression or emotion that is represented by the provided face.

According to an embodiment of the invention, the processing can be done either locally at the user's computer based device (e.g., smartphone) and/or remotely at the remote emoticons server (e.g., as presented in FIG. 5).

In another aspect the invention relates to a method for automatically identifying the person's mood and/or status (herby “mood”) in real-time through its own computer based device, such as PDA, smartphone, tablet, PC, laptop and the like, comprising:
a. recording the data captured by one or more sensors of said device, wherein said captured data represent the user behavior;
b. processing and analyzing the captured data by applying human behavior detection algorithm(s) for classifying the processed data as a possible user's mood;
c. determining the current mood of the user by locating the classification value resulting from the analysis of each captured data.

According to an embodiment of the present invention, the method further comprises a feedback module for generating an automatic response with respect to the user's current mood.

According to an embodiment of the invention, the predefined reference points are selected from the group consisting of: eyes, nose and bridge of the nose, mouth, lips, forehead, chin, cheek, eyebrows, hair, hairline, shoulder line or any combination thereof.

In another aspect the present invention relates to a system for providing personal emoticons, comprising:
a) at least one processor; and
b) a memory comprising computer-readable instructions which when executed by the at least one processor causes the processor to execute a personal emoticon engine, wherein the engine:
   processes at least one image of a self-portrait by applying one or more image processing filters and/or algorithms for performing at least one of the following tasks: enhancing said provided image, recognizing the face expression, and/or emphasizing the face expression represented by the provided image; and
   convertes said processed image into one or more emoticon/s format such that the image file is standardized into a pixel array of uniform dimensions to be used as personal emoticons in one or more applications and/or operating system based platforms by a software component that allows a user to enter characters on a computer based device.

### BRIEF DESCRIPTION OF THE DRAWINGS

In the drawings:

FIG. 1 shows an exemplary system 10 for creating personal emoticons, according to an embodiment of the invention;

FIG. 2 schematically illustrates an exemplary layout of a guiding mask layer, according to an embodiment of the invention;

FIG. 3A shows a list of personal emoticons of the same user, wherein each represents a different emotion and face expression;

FIG. 3B shows a list of personal emoticons of the same user implemented in an on-screen keyboard form;

FIG. 3C shows an implementation of personal emoticons in an instant messaging application the runs on a mobile device;

FIG. 4 shows predefined reference points on top of the a self-portrait image;

FIG. 5 schematically illustrates an exemplary computing system suitable as an environment for practicing aspects of the subject matter, according to an embodiment of the present invention; and

FIG. 6 schematically illustrates, in flow chart form, a process of providing personal emoticons, according to an embodiment of the invention.

### DETAILED DESCRIPTION OF THE INVENTION

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein. Moreover, reference in this specification to “one implementation” or “an implementation” means that a particular feature, structure, or characteristic described in connection with the implementation is included in at least one implementation of the subject matter. The appearances of the phrase “in one implementation” in various places in the specification are not necessarily all referring to the same implementation.

The subject matter described herein includes methods and devices for creating personal emoticons from images not previously associated with emoticons, such as emotions that uniquely expressed by the real face of a user.

According to an embodiment of the invention, in addition of selecting from a necessarily limited host of pre-packaged emoticons, users can create their own personal expressed emoticons by adapting many sorts of self-portrait image files to be used as their personal emoticons. In one implementation, image files of various types and sizes are each standardized into a pixel array of uniform dimensions to be used as emoticons.

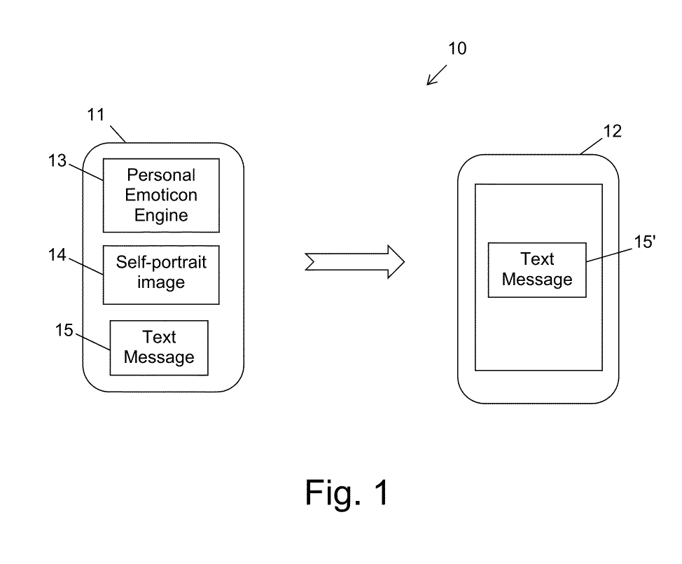

FIG. 1 shows an exemplary system 10 for creating personal emoticons, according to an embodiment of the invention. Multiple network nodes (e.g., mobile terminal units 11, 12) are communicatively coupled so that users may communicate using instant messaging, a chat application (e.g., WhatsApp), email client, etc. In one implementation, node 11 includes a personal emoticon engine 13. Engine 13 allows a user to convert a self-portrait image 14 into a personal emoticon (e.g., by converting a photo of a self-portrait image that was captured by a camera of a smartphone into a personal emoticon based on the face in the captured image).

According to an embodiment of the invention, the creation process of a personal emoticon may involve the following steps:
providing a self-portrait image 14 that represent a face expression of a user, either by capturing a new self-portrait image or by selecting an existing self-portrait image file;
processing the provided self-portrait image 14 by applying one or more image processing filters and or algorithms to said image for performing at least one of the following tasks: enhancing said provided image, emphasizing the expression represented by the submitted face, recognizing the face expression, or any combination of these tasks.

According to an embodiment of the invention, the creation process of a personal emoticon may further involve the following steps:
converting said processed image into an emoticon standardized form;
storing said processed image locally (e.g., at the mobile device in which the personal emoticon has been created) and/or in a remote emoticons server, e.g., by uploading the personal emoticons from a mobile device to the remote emoticons server. The remote emoticons server may also be used for approval of the personal emoticon; and
adding said processed image into an online account of a registered user, such that the personal emoticons will be available to be used in one or more applications and/or platforms that works under multiple suitable Operating Systems (OS).

According to an embodiment of the invention, when capturing a self-portrait image, a user may capture one or more photos with:
a neutral expression—meaning essentially with no particular emotions; or
a facial expressing in a specified/suggested emotions (e.g., smile). For example, a book by Ekman, Paul (2003) Emotions Revealed, New-York: Henry Holt and Co. describes how to imitates a facial expression, such as imitating the facial movement of sadness, fear, anger, etc.

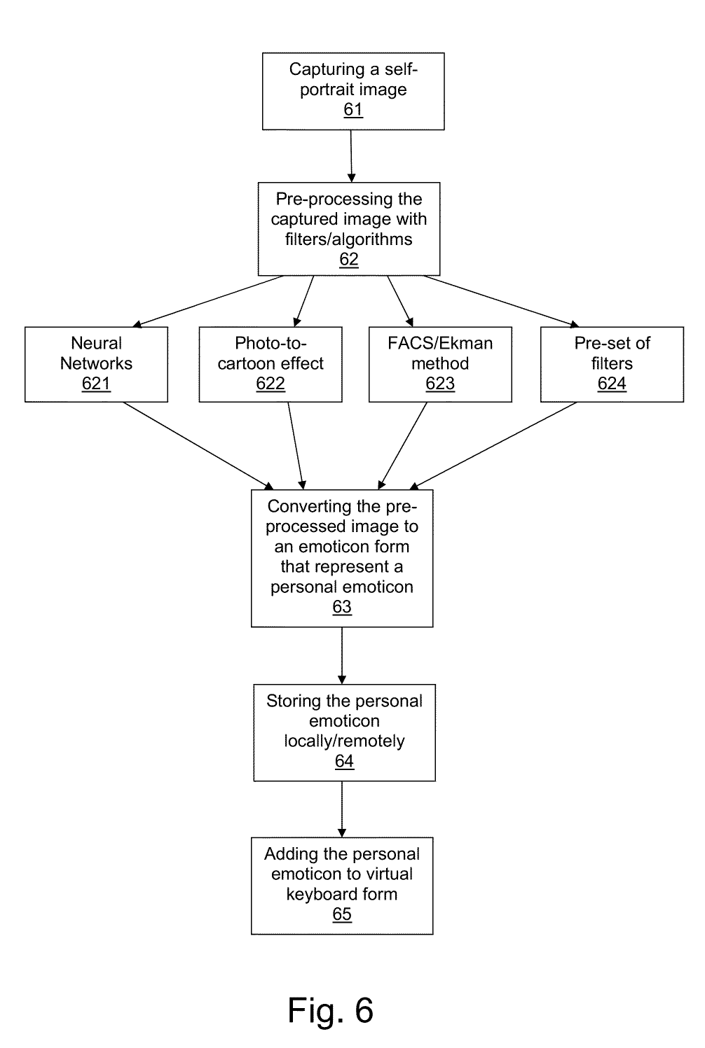

FIG. 6 schematically illustrates, in flow chart form, a process of providing personal emoticons, according to an embodiment of the invention. The process may involve the steps of:
capturing a self-portrait image (block 61);
pre-processing the captured image with filters/algorithms (block 62). Examples for different algorithms/filters that can be applied to the image are indicated by blocks 621-624 and will be described in further details hereinafter;
converting the pre-processed image to an emoticon form thereby creating a personal emoticon (block 63);
each personal emoticon can be stored locally in the device used for creating the personal emoticon or remotely at a corresponding server or cloud platform (block 64); and
adding the personal emoticon to a virtual keyboard or other software component that allows a user to enter characters.

A pre-processing of the provided image may be applied to verify that the captured image complies with certain criteria and to prepare the photo for further processing. The pre-processing may involve the applying of one or more image processing algorithms and/or filters for performing tasks such as:
face recognition that allows to identify human and/or filter inappropriate content from images that don't match the emoticons creation specifications, such as: light & contrast, human face, problematic background and the like;
processing that may identify one or more parts of the face: such as hair, mouth, eyes, eye brows, etc.;
desaturation of image—may remove all color from the image;
processing that may add more drawing lines to the face in order to make it more sketchy;
processing that may re-color the face & hair by applying different hex colors to the different identified parts.

According to an embodiment of the invention, the processing of the said pre-processed image may involve the applying of one or algorithms to recognize a facial expression and/or to create/generate one or more new personal emoticons that each may convey a facial expression, in particular based on one or more of the following methods:

i. Neural Networks (block 621) adapted for learning N faces with desired emoticon and applying the algorithm to the N+1 face;
ii. Photo-to-cartoon (block 622)—Vector drawing the outlines of the recognized face and accordingly transforming the image to a painting and/or caricature that express the facial expression provided by the recognized face;
iii. Learning the personal emotion through analysis of the face tonus or action units (AU) of the face known as Facial Action Coding System (FACS), such as the Ekman method (block 623). This may enable to set a personal emotion as a user's mood. Facial Action Coding System (FACS) is a system to taxonomize human facial movements by their appearance on the face, based on a system originally developed by a Swedish anatomist named Carl-Herman Hjortsjö that was later adopted by Paul Ekman and Wallace V. Friesen (P. Ekman and W. Friesen. “Facial Action Coding System: A Technique for the Measurement of Facial Movement”. Consulting Psychologists Press, Palo Alto, 1978). Movements of individual facial muscles are encoded by FACS from slight different instant changes in facial appearance. An algorithm based on FACS can be established as a computed automated system that detects faces in images or set of images, extracts the geometrical features of the faces, and then produces temporal profiles of each facial expression. For example, researchers through over 40 years of investigation have identified seven “basic” emotions with corresponding universally displayed and understood facial expressions: Joy, Sadness/Distress, Anger, Fear, Disgust, Contempt and Surprise (e.g., as disclosed in the website at the URL address http://www.facscodinggroup.com/universal-expressions). The learning of the personal mood through analysis of the face tonus or action units (AU) or FACS can be implemented based on several coding techniques such as described in a publication by Cohn, J. F., Ambadar, Z., & Ekman, P. (2007). “Observer-based measurement of facial expression with the Facial Action Coding System”. In J. A. Coan & J. J. B. Allen (Eds.), The handbook of emotion elicitation and assessment. Oxford University Press Series in Affective Science (pp. 203-221). New York, N.Y.: Oxford University.
iv. Breaking the face into predefined units (i.e., eyes, lips, nose, ears and more), processing each unit by itself by a predefined specific calculation and then assemble all units together to create the face with the desired emoticon.

Other processing of the pre-processed image may involve the applying of a pre-set of other filters (block 624) to change a face that appears in the photo to an emoticon, such as: replacing the original background in the photo with other background (e.g., by distinguishing between the face in the image and the background or other objects that may also appear in the original captured photo), applying one or more filters that turn photos into drawings or paintings (e.g., applying a pre-set of filters that may result in a photo-to-cartoon effect as can be done with filters such as used in popular software such as Photoshop by Adobe Systems Incorporated).

According to some embodiments of the invention, a personal emoticon can be provided by editing an image, or by using a photograph or drawing application to create self-portrait image for the personal emoticon from scratch. For example, once a user has adopted a self-portrait image 14 to be a personal emoticon, node 11 allows the user to send an instant message 15 that contains one or more personal emoticons 14 appear at appropriate places in the display of the instant message 15′ at the receiving mobile terminal unit 12.

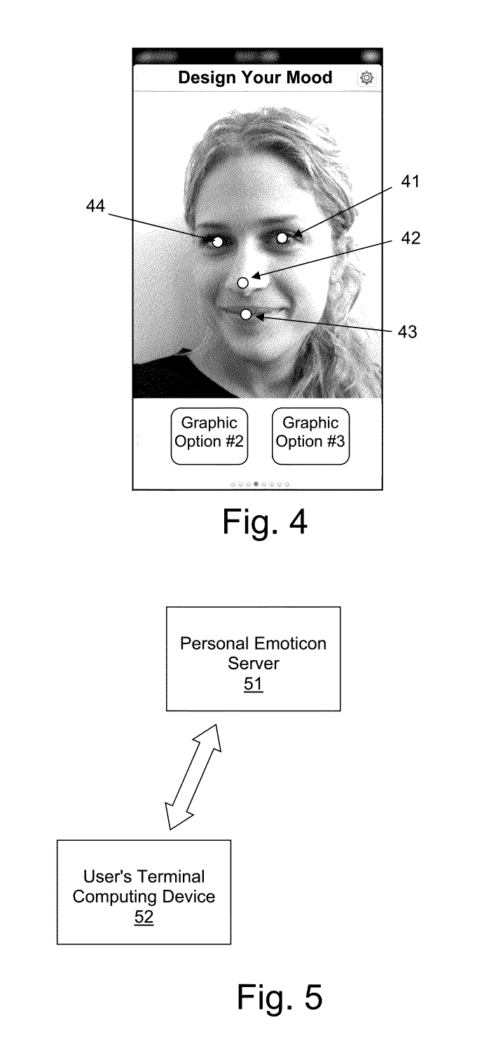

Personal emoticon engine 13 typically resides on a client that is on a computing device such as mobile terminal unit 11. An exemplary computing device environment suitable for engine 13 and suitable for practicing exemplary methods described herein is described with respect to FIG. 5.

According to an embodiment of the invention, engine 13 may include the following elements: a user interface that may include a “define personal emoticons” module, an image selector that may also include a pixel array generator, a character sequence assignor, such that keyboard keystrokes or textual alphanumeric “character sequences” are assigned as placeholders for personal emoticons within a message. A personal emoticon or its associated placeholder character sequence can be entered in an appropriate location of a real-time message during composition of the message.

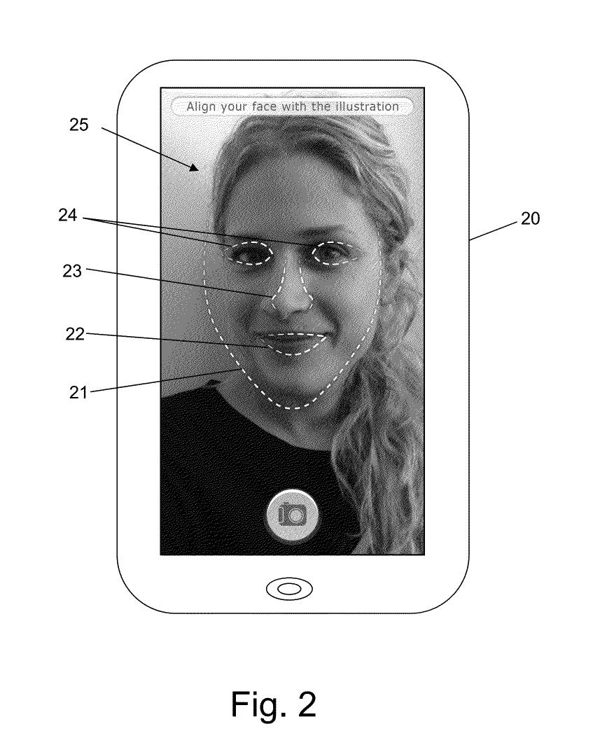

As controlled by an automatic process or by a user through a “define personal emoticons” dialogue generated by a module of the user interface. The define personal emoticon may include a guiding mask layer on top of a live image that is displayed on a screen of an image capturing device (such as a smartphone), for allowing positioning the user's face in an appropriate image position during the capturing of a new self-portrait image. For example, the capturing of a new self-portrait image involves the displaying of the guiding mask layer on top of a live image that is displayed on a screen of the smartphone, thereby allowing positioning the user's face in an appropriate image capturing position. FIG. 2 schematically illustrates an exemplary layout of such guiding mask layer as indicated by the dotted lines 21-24. In this exemplary figure, a live image 25 of a person's face is displayed on the screen of a smartphone 20. Optimal results may obtain when the person's face is aligned with guiding mask layer, such that the person's eyes are essentially aligned with the dotted lines 24 that represent the eyes area, the person's nose with dotted line 23 that represent the nose area, the person's mouth with dotted line 22 that represent the lips area and the person's general face line with dotted line 21 that represent the face line.

An image selector captures an image and converts the image to an emoticon. In one implementation, images of various sizes and formats, such as the joint photographic experts group (JPEG) format, the tagged image file format (TIFF) format, the graphics interchange format (GIF) format, the bitmap (BMP) format, the portable network graphics (PNG) format, etc., can be selected and converted into emoticons by a pixel array generator, which converts each image into a pixel array of pre-determined dimensions, such as 19×19 pixels. An image may be normalized in other ways to fit a pre-determined pixel array grid. For example, if the pre-determined pixel array for making a personal emoticon is a 19×19 pixel grid, then the aspect ratio of an image that does not fill the grid can be maintained by adding background filler to the sides of the image to make up the 19×19 pixel grid.

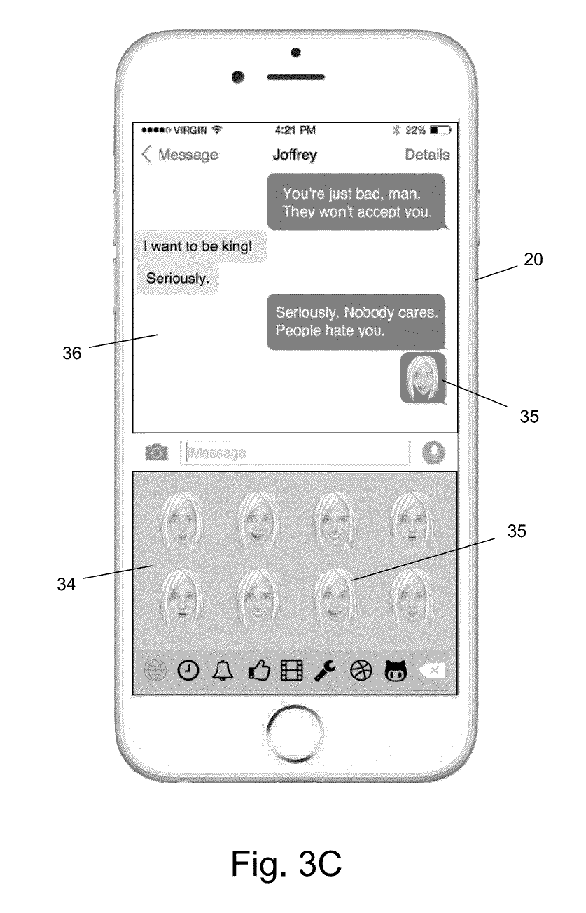

According to an embodiment of the invention, engine 13 comprises the generation of additional self-portrait emotions images that are derived from a single self-portrait image. The generation of additional self-portrait images with mood may involve the one or more of the following steps:
allowing a user to mark predefined reference points on top of the single self-portrait image (e.g., as indicated by the white dots 41-44 in FIG. 4). Each reference point represents a facial element with respect to the gender of the user. The predefined reference points can be: eyes, nose and bridge of the nose, mouth, lips, forehead, chin, cheek, eyebrows, hair, hairline, shoulder line or any combination thereof;
applying image processing algorithm(s) to that single self-portrait image according to the marked predefined reference points and the relation between their location with respect to a reference human face, such that each additional generated self-portrait emotion image will express a different expression or emotion that is represented by variations of the user's face.

In one implementation, engine 13 also includes advanced image editing features to change visual characteristics of an adopted image so that the image is more suitable for use as a personal emoticon. For example, an advanced image editor may allow a user to select the lightness and darkness, contrast, sharpness, color, etc. of an image. These utilities may be especially useful when reducing the size of a large image into a pixel array dimensioned for a modestly sized custom emoticon.

Each new personal emoticon can be saved in personal emoticons object storage together with associated information, such as a character sequence for mapping from an instant message to the emoticon and optionally, a nickname, etc. In one implementation, a nickname serves as the mapping character sequence, so that a personal emoticon is substituted for the nickname each time the nickname appears in an instant message. The personal emoticons object storage can be located either locally within the mobile terminal unit 11 or remotely at a remote emoticons server (e.g., see server 51 in FIG. 5) associated with engine 13.

The character sequence assignor may utilize a “define personal emoticons” dialogue or an automatic process to associate a unique “character sequence” with each personal emoticon that reflects a specific emotion or face expression. A character sequence usually consists of alphanumeric characters (or other characters or codes that can be represented in an instant message) that can be typed or inserted by the same text editor that is creating an instant message. Although keystrokes imply a keyboard, other conventional means of creating an instant message can also be used to form a character sequence of characters or codes to map to a personal emoticon.

In one implementation, character sequences are limited to a short sequence of characters, such as seven. The character sequence “happy” can result in a personal emoticon of the user's self-portrait that expresses a smiling face appearing each “happy” is used in a message, so other characters may be added to common names to set mappable character sequences apart from text that does not map to a personal emoticon. Hence a character sequence may use brackets, such as [happy] or an introductory character, such as #happy.

It should be noted that engine 13 can be implemented in software, firmware, hardware, or any combination thereof. The illustrated exemplary engine 13 is only one example of software, firmware, and/or hardware that can perform the subject matter.

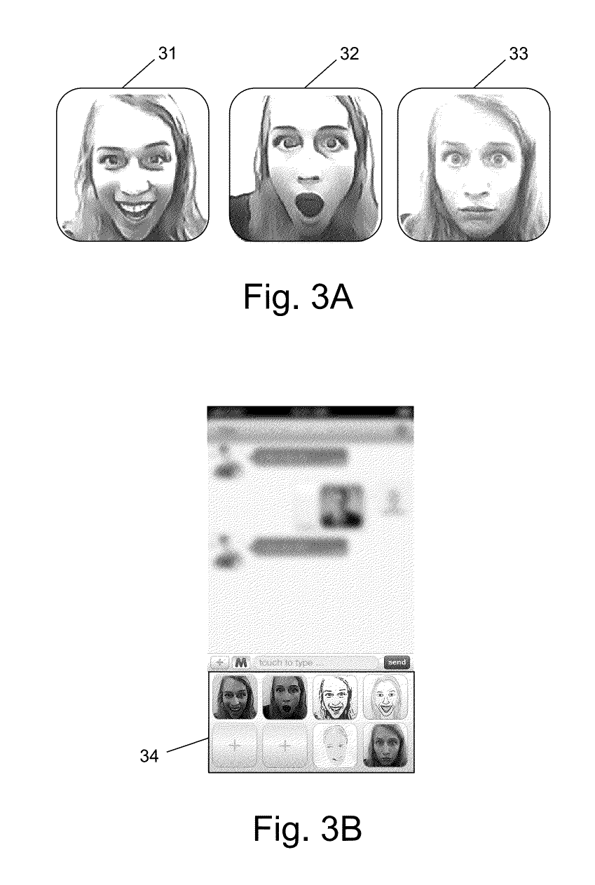

FIG. 3A shows variety of personal emoticons of the same user, wherein each of which represents a different mood via a different face expression (as indicated by numerals 31-33 as follows: happy mood 31, astonished face 32 and frightened 33). In some implementations, the list of personal emoticons can be part of a software component that allows a user to enter characters such as a dialogue box or an on-screen virtual keyboard-like form (e.g., as shown in the form of a virtual keyboard layout portion 34 in FIG. 3B) for selecting one or more of the personal emoticons for editing or for insertion into an instant message—in which case a selected personal emoticon from the list or a corresponding assigned character sequence that maps to the custom emoticon is inserted in an appropriate location in the instant message. FIG. 3C shows an implementation of personal emoticons in a virtual keyboard form 34 as part of an instant messaging (IM) application 36 the runs on a mobile device 20. In this example, a personal emoticon 35 is used during a chat session while using the IM application 36.

In one implementation, elements of a list of personal emoticons can be shown in a tooltip that appears on a display when the user hovers with a pointer over a user interface element. For example, a tooltip can appear to remind the user of available personal emoticons. In the same or another implementation, a tooltip appears when the user points to a particular personal emoticon in order to remind of the character sequence and nickname assigned to that emoticon. In the same or yet another implementation, a list of personal emoticons appears as a pop-down or unfolding menu that includes a dynamic list of a limited number of the custom emoticons created in a system and/or their corresponding character sequences.

For example, when a user writes a message (such as a real-time instant message, email and the like), a personal emoticon can be inserted along with the other instant of the message.

### An Example of a Suitable Computing Environment for Implementing the Method of the Invention

The following discussions are intended to provide a brief, general description of a suitable computing environment in which the invention may be implemented. While the invention will be described in the general context of program modules that execute in conjunction with an application program that runs on an operating system on a Personal Computer (PC) or a mobile device, those skilled in the art will recognize that the invention may also be implemented in combination with other program modules resides on servers such as cloud computing or terminal devices such as: notebooks, wearable computing device (e.g., smart watch), smartphones and tablets.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, and the like. The invention may also be practiced in distributed computing environments where tasks are performed by remote processing devices that are linked through a communications network, such as a smartphone and the remote emoticons server. In a distributed computing environment, program modules, stored self-portrait images and derived personal emotions may be located in both local and remote memory storage devices.

Embodiments of the invention may be implemented as a computer process (method), a computing system, or as a non-transitory computer-readable medium comprising instructions which when executed by at least one processor causes the processor to perform the method of the present invention. The computer program product may be a computer storage media readable by a computer system and encoding a computer program of instructions for executing a computer process. The computer program product may also be a propagated signal on a carrier readable by a computing system and encoding a computer program of instructions for executing a computer process.

Unless otherwise indicated, the functions described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order.

FIG. 5 shows an exemplary computing system 50 suitable as an environment for practicing aspects of the subject matter, for example for online creation (applying the image processing) and/or storage of the personal emoticon(s). The components of computing system 50 include a remote emoticon server 51 and plurality of clients 52 (e.g., the client can be implemented as an application on a smartphone). The client 52 may (among other of its functions) locally process the image/s and/or store the personal emoticon/s. The server 51 may include, but are not limited to, a processing unit, a system memory, and a system bus that couples various system components including the system memory to the processing unit and/or storage of the personal emoticon(s).

Server 51 typically includes a variety of computing device-readable media. Computing device-readable media can be any available media that can be accessed by server 51 and includes both volatile and nonvolatile media, removable and non-removable media. By way of example, and not limitation, computing device-readable media may comprise computing device storage media and communication media. Computing device storage media include volatile and nonvolatile, removable and non-removable media implemented in any method or technology for storage of information such as computing device-readable instructions, data structures, program modules, or other data. Computing device storage media includes, but is not limited to, RAM, ROM, EEPROM, flash memory or other memory technology, or any other medium which can be used to store the desired information and which can be accessed by server 51. Communication media typically embodies computing device-readable instructions, data structures, program modules or other data in a modulated data signal such as a carrier wave or other transport mechanism and includes any information delivery media.

In another aspect the invention relates to a method for automatically identifying the person's mood in real-time through its own computer based device, such as PDA, smartphone, tablet, PC and the like. The method comprises:
recording the data captured by one or more sensors of the computer based device and/or in conjunction with other related inputs to the device, wherein said captured data represent the user behavior;
processing and analyzing the captured data by applying human behavior detection algorithm(s) for classifying the processed data as a possible user's mood;
determining the current mood of the user by locating the classification value resulting from the analysis of each captured data, (e.g., a higher value indicates an angry mood of the user, and a lower value indicates a happy mood of the user).

After the automatic mood identification, a dedicated application may change the mood status of the user to the detected one. Of course, in such case either the personal emoticon can be displayed or alternatively, the common emoticon or a represented text message can be used.

Any sensor/module exist in the computer based device can be used, either by itself or in combination with other sensors, as a data capture input source, such as a microphone (e.g., user's voice), a camera (e.g., user's face), tilt sensor (e.g., movement rate of user's hand), typing rate on the on-screen virtual keyboard, light sensitive sensor, time (e.g., day or night), and the like. For example, the user's voice tone level in combination with the user's face expression may indicate whether the user is angry or not.

### Development of Moods Classification Rules Set

The development of rules is done according to the following process:
1. Recording of data captured by the one or more sensors of the device during at least one capturing session (e.g., user's voice tone, typing speed, movement's rate of the mobile device, captured images and the like).
2. Calculation of parameters (e.g., average, standard deviation, coefficient of variance, median, inter-quartile range, integral over the time, minimum value, maximum value, number of times that the signal is crossing the median during a specific time segment) for data recorded during each capturing session, and building a data base including the mood classification and the calculated parameters, for each individual user.
3. Applying human behavior analysis software with algorithms for identifying the rules for the prediction of moods classification, based on the calculated parameters of a certain captured records.
4. Providing a computer program that uses the set of rules to classify the mood type of each record.

According to an embodiment of the present invention, system 10 further comprises a feedback module (not shown) for allowing generating an automatic response with respect to the mood currently set for the user. Each mood may have one or more response actions that are related to it and that can be applied by the user's own device, such as playing a specific song, displaying a specific image, vibrating, sending a message to one or more selected contacts, changing the Instant messaging (IM) status and displaying one or more personal emoticons from software component that allows a user to enter characters such as a virtual keyboard form, etc. In one implementation, the generated responses can be set in advance by the user, such as determining a specific image to be displayed on the screen of the device when user's mood is set to unhappy, playing a selected song from a predetermined list of songs, etc.

In another implementation, the generated responses can be set automatically according to predefined set of rules that can be based on common human behavioral research and methodologies, such as “color psychology”, which is the study of color as a determinant of human behavior (which is a well-known study described, for instance in “http://en.wikipedia.org/wiki/Color_psychology”). According to this, in an unhappy or angry mood the feedback module may generate a response that may cheer up the user. For example, when the user's mood is set to “angry” the feedback module may display a specific color that might reduce the “angry” level of the user or might even cause the user to change his/her mood.

According to an embodiment of the present invention, system 10 can be configured to automatically change the mood/status of a user in variety of applications and/or Operation System (OS) platforms. For example, this can be done by using relevant Application Programming Interface (API), such that the current status/mood of the user will be applied as the user status in almost any social related application or software module such as third party applications (e.g., Skype, ICQ, Facebook, etc.) or dedicated applications, whether such status/mood availability is already an integral part of an application or not. In case the user's status/mood availability in not an integral part of an application or OS, than the user's status/mood can be applied as an add-on module for such application/OS.

### CONCLUSION

The subject matter described above can be implemented in hardware, in software, or in firmware, or in any combination of hardware, software, and firmware. In certain implementations, the subject matter may be described in the general context of computer-executable instructions, such as program modules, being executed by a computing device or communications device. Generally, program modules include routines, programs, objects, components, data structures, etc. that performs particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

The foregoing discussion describes exemplary personal emoticons, methods of creating, storing and using personal emoticons, and an exemplary emoticon engine. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Similarly, while certain examples may refer to a mobile terminal unit such as a smartphone, other computer or electronic systems can be used as well whether they are mobile systems or not, such as, without limitation, a tablet computer, a Personal Computer (PC) system, a network-enabled Personal Digital Assistant (PDA), a network game console, a networked entertainment device and so on.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

The example screen layouts, appearance, and terminology as depicted and described herein, are intended to be illustrative and exemplary, and in no way limit the scope of the invention as claimed.

All the above description and examples have been given for the purpose of illustration and are not intended to limit the invention in any way. Many different mechanisms, methods of analysis, electronic and logical elements can be employed, all without exceeding the scope of the invention.

1. A method for providing personal emoticons, comprising the steps of:
a) providing at least one self-portrait image that represent a static face expression of an individual user;
b) processing said provided at least one image by applying one or more image processing filters and/or algorithms for performing at least one of the following tasks: enhancing said provided image, recognizing the face expression, and/or emphasizing the face expression represented by the provided image; and
c) converting said processed image into one or more emoticon/s format such that the image file is standardized into a pixel array of uniform dimensions to be used as personal emoticons in one or more applications and/or operating system based platforms by a software component that allows a user to enter characters on a computer based device.

2. The method according to claim 1, wherein the processing of the image involves the applying of one or algorithms, in particular based on one or more of the following methods:
i. Neural Networks by learning N faces with desired emoticon and applying the algorithm to the N+1 face;
ii. Vector drawing of the outlines of the recognized face, thereby transforming the image to a painting and/or caricature form that expresses the provided face;
iii. learning the personal mood through analysis of known tonus of the face's organs or action units;
iv. Breaking the face into predefined units (i.e., eyes, lips, nose, ears and more), processing each unit by itself by a predefined specific calculation and then assemble all units together to create the face with the desired emoticon.

3. The method according to claim 1, further comprises enabling to add the personal emoticons to a software component that allows a user to enter characters in a mobile and or PC device, in particular the software component is in form of a virtual keyboard or a ruler/menu, wherein said personal emoticons is either stored in said mobile device or at a remote server.

4. The method according to claim 1, further comprises storing the personal emoticons in a remote emoticons server for adding said personal emoticons into an on-line account associated with the individual user, thereby enabling to use said personal emoticons in a variety of applications and/or platforms.

5. The method according to claim 4, wherein the personal emoticons are added by uploading said personal emoticons to the remote emoticons server for approval and upon approval, adding said personal emoticons into an on-line account associated with the user, such that said personal emoticons will be available to be used by said user as a one or more personal emoticons in one or more applications and/or Operation System (OS) platforms including changing the mood/status of the user in said applications and/or platforms whether such status/mood availability is already an integral part of an application or not.

6. A method according to claim 1, wherein the capturing of a new self-portrait image involves the displaying of a guiding mask layer on top of a live image that is displayed on a screen of an image capturing device (such as a smart-phone), for allowing positioning the user's face in an appropriate image capturing position.

7. A method according to claim 1, further comprises generating one or more additional self-portrait images deriving from the provided self-portrait image by performing one or more of the following steps:
a) allowing a user to mark predefined reference points on top of said provided self-portrait image, wherein each reference point represent a facial parameter with respect to the gender of the user; and/or
b) applying image processing algorithm(s) to said provided self-portrait image according to said marked predefined reference points and the relation between their location with respect to a reference human face, such that each generated self-portrait image will express a different expression or emotion that is represented by the user's face.

8. A method according to claim 7, wherein the predefined reference points are selected from the group consisting of: eyes, nose, bridge of the nose, mouth, lips, forehead, chin, cheek, eyebrows, hair, hairline, shoulder line or any combination thereof.

9. A method according to claim 1, wherein the converted image(s) can be implemented in a ruler form, a menu form or as an on-screen virtual keyboard form in which a user can select and use one or more of those personal saved emotions from the above forms and use it within Instant Messages.

10. A method according to claim 1, further comprises automatically identifying the user's current mood in real-time through its own computer based device by performing the steps of:
a) recording the data captured by one or more sensors of the computer based device and/or in conjunction with other related inputs to the device, wherein said captured data represent the user behavior;
b) processing and analyzing the captured data by applying human behavior detection algorithm(s) for classifying the processed data as a possible user's mood; and
c) determining the current mood of the user by locating the classification value resulting from the analysis of each captured data.

11. A method according to claim 10, further comprises a feedback module for generating an automatic response with respect to the user's current mood, wherein each mood may have one or more response actions related to it that can be applied by the user's own device.

12. A method according to claim 11, wherein the actions are selected from the group consisting of: playing a specific song, displaying a specific image, vibrating, sending a message to one or more selected contacts or displaying a related personal emotion from a software component that allows a user to enter characters on a user computer based device.

13. A method according to claim 10, wherein the feedback module may generate a response that may cheer up the user in case of as an example an “unhappy” mood or an “angry” mood and thereby may cause the user to change the mood or reduce the mood level.

14. A method according to claim 10, further comprises automatically changing the mood/status of a user in variety of applications and/or Operation System (OS) platforms, according to the identified mood of said user.

15. A method for automatically identifying the person's mood in real-time through its own computer based device, comprising:
a) recording the data captured by one or more sensors of said device, wherein said captured data represent the user behavior;
b) processing and analyzing the captured data by applying human behavior detection algorithm(s) for classifying the processed data as a possible user's mood;
c) determining the current mood of the user by locating the classification value resulting from the analysis of each captured data; and
d) generating an automatic response with respect to the user's current mood by using a feedback module, wherein each mood have one or more response actions related to it that can be applied by the user's own device.

16. A method according to claim 15, wherein the automatic response involve the displaying of a personal emotion from a software component that allows a user to enter characters.

17. A method according to claim 15, wherein the feedback module may generate a response that may cheer up the user in case of an “unhappy” mood or an “angry” mood and thereby may cause the user to change the mood or reduce the mood level.

18. A method according to claim 15, further comprises automatically changing the mood/status of a user in variety of applications and/or Operation System (OS) platforms, according to the identified mood of said user.

19. A system for providing personal emoticons, comprising:
a) at least one processor; and
b) a memory comprising computer-readable instructions which when executed by the at least one processor causes the processor to execute a personal emoticon engine, wherein the engine:
i) processes at least one image of a self-portrait by applying one or more image processing filters and/or algorithms for performing at least one of the following tasks: enhancing said provided image, recognizing the face expression, and/or emphasizing the face expression represented by the provided image; and
ii) convertes said processed image into one or more emoticon/s format such that the image file is standardized into a pixel array of uniform dimensions to be used as personal emoticons in one or more applications and/or operating system based platforms by a software component that allows a user to enter characters on a computer based device.
